(19) United States
(12) Patent Application Publication
(10) Pub. No.: US 2026/0233719 A1
(43) Pub. Date: Aug. 13, 2026

(54) METHOD AND APPARATUS FOR CONTROLLING AUTONOMOUS EMERGENCY BRAKING SYSTEM

(71) Applicant: HL Klemove Corp., Incheon (KR)

(72) Inventor: Jungkeuk KIM, Incheon (KR)

(73) Assignee: HL Klemove Corp., Incheon (KR)

(21) Appl. No.: 19/225,748

(22) Filed: Jun. 2, 2025

(30) Foreign Application Priority Data
Feb. 13, 2025 (KR) 10-2025-0018628

(51) Int. Cl. B60T 8/1755; B60W 10/18; B60W 30/09; B60W 30/095; G06V 20/58

(52) U.S. Cl. CPC B60T 8/17558; B60W 10/18; B60W 30/09; B60W 30/0956; G06V 20/584; B60T 2201/022; B60W 2420/403; B60W 2554/402; B60W 2554/4045; G06V 2201/07; G06V 2201/08

(57) ABSTRACT

A method for controlling an Autonomous Emergency Braking (AEB) system according to an embodiment of the present disclosure comprises: recognizing a target in surroundings of an ego vehicle using a camera installed at the ego vehicle; determining an intention of the target using recognition information of the camera, the intention comprising at least one of an intention to decelerate or stop, an intention to move forward, or an intention to change direction; and controlling at least one of a warning timing or a braking timing of the AEB system of the ego vehicle, based on the determined intention of the target.

### CROSS-REFERENCE TO RELATED APPLICATION

This application claims the benefit of and priority to Korean Patent Application No. 10-2025-0018628 filed on Feb. 13, 2025, the entire disclosures of which are incorporated herein by reference.

### TECHNICAL FIELD

The present disclosure relates to a method and apparatus for controlling an Autonomous Emergency Braking (AEB) system. More specifically, the present disclosure relates to a method and apparatus for controlling an Autonomous Emergency Braking system that determines the intention of a target using camera recognition information and controls the AEB warning timing or braking timing according to the determined intention.

### BACKGROUND

In a vehicle, a Driver Assistance System provides support to the driver while driving for the driver's convenience.

For example, an Autonomous Emergency Braking System (AEB) refers to a function that reduces collision risk by automatically braking when the vehicle detects a risk of a front collision.

Meanwhile, the AEB system predicts the path of a target based on kinematic information of the target where a collision risk exists. However, if the target's motion state changes abruptly, the prediction of the target's path change may be delayed, which can cause problems in collision determination, leading to malfunctions or non-operation of the AEB system.

Therefore, there is a need for a method and apparatus for controlling an AEB system that can improve the accuracy of AEB warning and braking determination by using information available for determining the intention of the target in situations where there is a collision risk with the target, thereby predicting the target's motion state information in advance.

### SUMMARY

The present disclosure is to solve the problems of the prior art described above, and an object of the present disclosure is to provide a method and apparatus for controlling an AEB system that predicts changes in the target's motion state in advance by determining the target's intention, thereby controlling the AEB warning timing or braking timing.

Further, an object of the present disclosure is to provide a method and apparatus for controlling an AEB system that recognizes the posture of a pedestrian or a rider of a motorcycle to determine the intention to start or stop of the pedestrian or motorcycle, and utilizes this to control the AEB warning timing or braking timing of the ego vehicle.

However, the technical problems to be achieved by the embodiments of the present disclosure are not limited to the technical problems described above, and other technical problems may exist.

As a technical means for achieving the above technical problem, a method for controlling an AEB system according to an embodiment of the present disclosure comprises: recognizing a target in surroundings of an ego vehicle using a camera installed at the ego vehicle; determining an intention of the target using recognition information of the camera, the intention comprising at least one of an intention to decelerate or stop, an intention to move forward, or an intention to change direction; and controlling at least one of a warning timing or a braking timing of the AEB system of the ego vehicle, based on the determined intention of the target.

Further, the target may be one of a front vehicle, a front-side vehicle, a motorcycle, or a pedestrian.

Further, the determining of the intention of the target may comprise: if the target is the front vehicle, determining whether a turn signal of the front vehicle is operating; and if the turn signal is operating, determining the intention of the target as an intention to cut-out.

Further, the determining of the intention of the target may further comprise: if the turn signal of the front vehicle is not operating, determining whether a brake light of the front vehicle is operating; and if the brake light is operating, determining the intention of the target as an intention to decelerate or stop.

Further, the determining of the intention of the target may comprise: if the target is the front-side vehicle, determining whether a turn signal of the front-side vehicle is operating; if the turn signal of the front-side vehicle is operating, determining whether a direction of the turn signal corresponds to a direction towards a driving lane of the ego vehicle; and if the direction of the turn signal corresponds to the direction towards the driving lane, determining the intention of the target as an intention to cut-in.

Further, the determining of the intention of the target may comprise: if the target is the motorcycle, determining the intention of the target based on a posture of a rider of the motorcycle.

Further, the determining of the intention of the target may comprise: determining the intention as an intention to decelerate or stop if the posture is a posture that the rider has removed a foot from a pedal; and determining the intention as an intention to move forward if the posture is a posture that the rider has placed a foot on the pedal.

Further, the determining of the intention of the target may comprise: if the target is the pedestrian, determining the intention of the target based on a posture of the pedestrian.

Further, if the pedestrian is at a start portion of a crosswalk, the intention of the target may be determined as an intention not to enter the crosswalk if the posture of the pedestrian is a standing posture, and the intention of the target may be determined as an intention to enter the crosswalk if the posture of the pedestrian is a posture stepping forward.

An apparatus for controlling an Autonomous Emergency Braking (AEB) system according to embodiments of the present disclosure comprises: a first sensor comprising a camera configured to recognize a target in surroundings of an ego vehicle; a second sensor configured to detect body information of the ego vehicle; and a controller comprising at least one processor configured to control the AEB system of the ego vehicle by determining an intention of the target based on information collected from the first sensor and the second sensor, wherein the controller is configured to: determine the intention of the target, the intention comprising at least one of an intention to decelerate or stop, an intention to move forward, or an intention to change direction; and control at least one of a warning timing or a braking timing of the AEB system based on the determined intention of the target.

Further, the target may be one of a front vehicle, a front-side vehicle, a motorcycle, or a pedestrian.

Further, if the target is the front vehicle, the controller may be configured to: determine whether a turn signal of the front vehicle is operating; and if the turn signal is operating, determine the intention of the target as an intention to cut-out.

Further, the controller may be configured to: if the turn signal of the front vehicle is not operating, determine whether a brake light of the front vehicle is operating; and if the brake light is operating, determine the intention of the target as an intention to decelerate or stop.

Further, if the target is the front-side vehicle, the controller may be configured to: determine whether a turn signal of the front-side vehicle is operating; determine whether a direction of the turn signal corresponds to a direction towards a driving lane of the ego vehicle; and if the direction of the turn signal corresponds to the direction towards the driving lane, determine the intention of the target as an intention to cut-in.

Further, if the target is the motorcycle, the controller may be configured to determine the intention of the target based on a posture of a rider of the motorcycle.

Further, the controller may be configured to: determine the intention as an intention to decelerate or stop if the posture is a posture that the rider has removed a foot from a pedal; and determine the intention as an intention to move forward if the posture is a posture that the rider has placed a foot on the pedal.

Further, if the target is the pedestrian, the controller may be configured to determine the intention of the target based on a posture of the pedestrian.

Further, the controller may be configured to: if the pedestrian is at a start portion of a crosswalk, determine the intention of the target as an intention not to enter the crosswalk if the posture of the pedestrian is a standing posture; and determine the intention of the target as an intention to enter the crosswalk if the posture of the pedestrian is a posture stepping forward.

Further, the controller may be connected to: a braking apparatus configured to perform braking control of the ego vehicle; and a warning apparatus configured to provide a warning to a driver of the ego vehicle, and the controller may be configured to control at least one of the braking apparatus or the warning apparatus according to the controlled warning timing or braking timing of the AEB system to perform an AEB function.

Meanwhile, in a non-transitory computer-readable recording medium that records a program for executing a method for controlling an AEB system according to an embodiment of the present disclosure, the method comprises: recognizing a target in surroundings of an ego vehicle using a camera installed at the ego vehicle; determining an intention of the target using recognition information of the camera, the intention comprising at least one of an intention to decelerate or stop, an intention to move forward, or an intention to change direction; and controlling at least one of a warning timing or a braking timing of the AEB system of the ego vehicle, based on the determined intention of the target.

The above-described means for solving the problem is only exemplary and should not be construed as limiting the present disclosure. In addition to the exemplary embodiments described above, additional embodiments may exist in the drawings and the following detailed description.

According to the problem-solving means of the present disclosure described above, by rapidly determining the intention of a target, it is possible to provide a method and apparatus for controlling the AEB system that enables accurate AEB determination for the target that stops or starts abruptly, thereby preventing mis-control or non-control problem of the AEB system.

Further, according to the present disclosure, by determining the intention of the target, it is possible to provide a method and apparatus for controlling the AEB system that enables accurate AEB determination for cut-in and cut-out targets, thereby improving the accuracy of AEB warning and braking determination.

However, the effects obtainable from the present disclosure are not limited to the effects described above, and other effects may exist.

### BRIEF DESCRIPTION OF THE DRAWINGS

FIG. 1 is a control flowchart showing a method for controlling an AEB system according to an embodiment of the present disclosure.

FIG. 2 is a diagram illustrating types of camera information in the method for controlling an AEB system according to the embodiment of the present disclosure.

FIG. 3A is a control flowchart showing in more detail the target intention determination step if the target is a front vehicle, and FIG. 3B is a control flowchart showing in more detail the target intention determination step if the target is a front-side vehicle, in the method for controlling an AEB system according to the embodiment of the present disclosure.

FIG. 4 is a diagram for explaining AEB target processing and a control method based on the determination of the target's intention to move or stop if the target is a front vehicle.

FIG. 5 is a diagram for explaining AEB target processing and a control method based on the determination of the target's cut-out/cut-in intention when the target is a front vehicle or front-side vehicle.

FIGS. 6A and 6B are diagrams for explaining the method of determining the target's intention if the target is a motorcycle in the method for controlling an AEB system according to the embodiment of the present disclosure.

FIGS. 7A and 7B are diagrams for explaining the method of determining the target's intention if the target is a pedestrian in the method for controlling an AEB system according to the embodiment of the present disclosure.

FIG. 8 is a control configuration diagram schematically showing the configuration of an apparatus for controlling an AEB system according to embodiments of the present disclosure.

### DETAILED DESCRIPTION

Hereinafter, with reference to the accompanying drawings, embodiments of the present disclosure will be described in detail so that those skilled in the art can easily practice the embodiments. However, the present disclosure may be implemented in many different forms and is not limited to the embodiments described herein. In addition, in order to clearly describe the present disclosure in the drawings, parts irrelevant to the description are omitted, and similar reference numerals are attached to similar parts throughout the present disclosure.

Throughout the present disclosure, if a part is said to be “connected” to another part, it is not only “directly connected”, but also “electrically connected” with another element in between, including cases

### Where They Are “indirectly Connected”.

Throughout the present disclosure, if one member is said to be located “on”, “above”, “under”, or “below” the other member, this includes not only the case of being in contact with the other member, but also the case that another member is positioned between the two members.

Throughout the present disclosure, if a part “includes” a certain component, it does not mean excluding other components, and it does mean that it may further include other components, unless otherwise stated.

Various embodiments of the present disclosure generally relate to a method and apparatus for controlling an Autonomous Emergency Braking (AEB) system, which determines an intention of a target using camera recognition information and controls the warning timing or braking timing of the AEB system according to the determined intention.

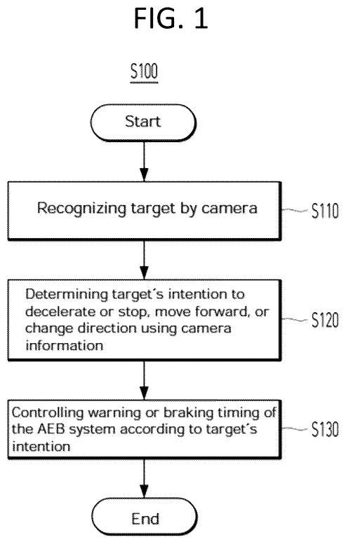

FIG. 1 is a control flowchart showing a method for controlling an AEB system according to an embodiment of the present disclosure.

Referring to FIG. 1, a method for controlling an AEB system S100 according to an embodiment of the present disclosure may comprise recognizing a target in the surroundings of the ego vehicle using a camera installed at the ego vehicle S110. For example, a target in the surroundings of the ego vehicle may be recognized by a front camera installed at the windshield of the ego vehicle.

Subsequently, determining the intention to decelerate or stop, intention to move forward, or intention to change direction of the target using recognition information of the camera S120 may be performed. Here, the intention to change direction may include the intention of the target to cut-in into or cut-out from the lane where the ego vehicle is driving.

Generally, an AEB system performs warning or braking control based on the collision risk between the ego vehicle and the target. Here, the collision risk may be calculated based on the distance and relative speed between the ego vehicle and the target using TTC (Time To Collision), and if the TTC is below a predetermined threshold value, warning and/or braking control according to AEB may be performed.

That is, the conventional AEB control performs warning and/or braking control based on kinematic data. Accordingly, if the target's motion state changes abruptly, the determination on the target's path change may be delayed.

In contrast, in the target intention determination step S120 according to the embodiment, by determining the intention to decelerate or stop, intention to move forward, or intention to change direction of the target using camera recognition information, it is possible to quickly cope with changes even when the target's motion state changes abruptly.

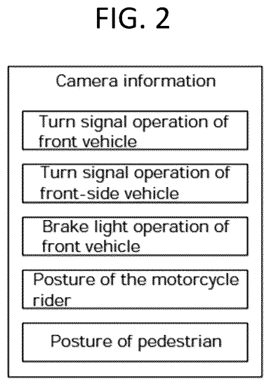

Regarding the determination of the target's intention using the recognition information of the camera, a more detailed description will be provided with reference to FIGS. 2 to 7.

Subsequently, controlling at least one of the warning timing and braking timing of the AEB system based on the determined intention of the target S130 may be performed.

For example, controlling at least one of the warning timing and braking timing of the AEB system may involve advancing or delaying the warning timing and/or braking timing according to the AEB based on the target's intention.

According to the method for controlling the AEB system according to the embodiment described above, by determining the target's intention based on the target's image information, it is possible to predict the target's movement, and accordingly, it is possible to improve the AEB control performance by flexibly changing the AEB warning and/or braking timing.

FIG. 2 is a diagram illustrating types of camera information in the method for controlling an AEB system according to the embodiment of the present disclosure.

The target in the present disclosure may be one of a front vehicle, a front-side vehicle, a motorcycle, or a pedestrian. Referring to FIG. 2, the recognition information of the camera according to the embodiment may include turn signal operation of the front vehicle, turn signal operation of the front-side vehicle, brake light operation of the front vehicle, the posture of the motorcycle rider, the posture of the pedestrian, etc.

Hereinafter, regarding the method for determining the target's intention according to the type of target, a more detailed description will be provided.

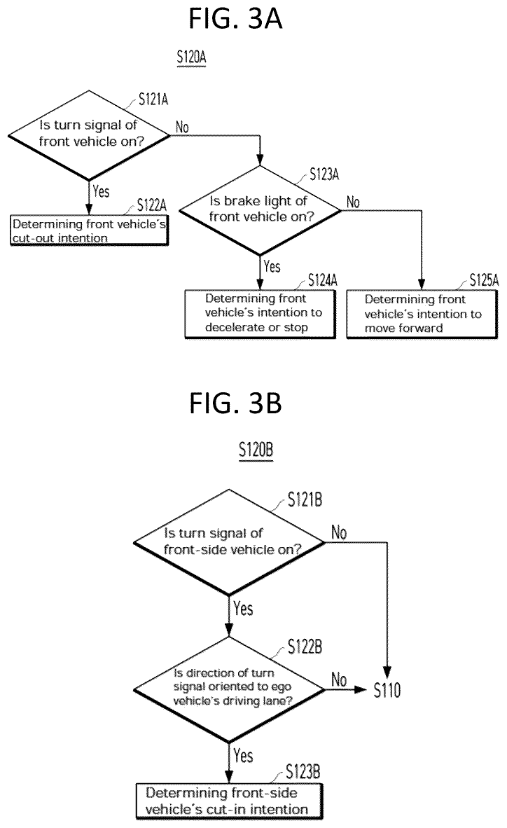

FIG. 3A is a control flowchart showing in more detail the target intention determination step if the target is a front vehicle, and FIG. 3B is a control flowchart showing in more detail the target intention determination step if the target is a front-side vehicle, in the method for controlling an AEB system according to the embodiment of the present disclosure.

Referring to FIG. 3A, the target intention determination step S120A if the target is a front vehicle may include a step of determining whether the turn signal of the front vehicle is operating S121A. If the turn signal is operating (‘Yes’ in S121A), the intention of the target may be determined as intention to cut-out (S122A).

This is because if the driver of the front vehicle located in the driving lane of the ego vehicle operates the turn signal, it may be estimated that the intention of the front vehicle's driver is to change lanes. Therefore, the intention of the target (front vehicle) to cut-out (lane change) may be determined through whether the turn signal of the front vehicle is operating.

If it is determined that the front vehicle has an intention to cut-out, the control timing in the AEB control based on the front vehicle may be delayed. This is because if the front vehicle performs cut-out, the collision risk with the front vehicle will decrease. Therefore, if the front vehicle's intention to cut-out is determined, the AEB warning timing and/or braking control timing may be controlled to be later than normal AEB control.

Meanwhile, if the turn signal of the front vehicle is not operating (‘No’ in S121A), it may be determined whether the brake light of the front vehicle is operating (S123A). If the brake light of the front vehicle is operating (‘Yes’ in S123A), the intention of the target may be determined as intending to decelerate or stop (S124A). Meanwhile, if the brake light of the front vehicle is not operating (‘No’ in S123A), it may be determined that the front vehicle has an intention to move forward (S125A).

This is because if the driver of the front vehicle located in the driving lane of the ego vehicle operates the brake light, it may be estimated that the intention of the front vehicle's driver is to decelerate or stop. Therefore, the intention of the target (front vehicle) to decelerate or stop may be determined through whether the brake light of the front vehicle is operating.

If it is determined that the front vehicle has an intention to decelerate or stop, the control timing in the AEB control based on the front vehicle may be advanced. This is because if the front vehicle decelerates or stops, the collision risk with the front vehicle will increase. Therefore, if the intention of the front vehicle to decelerate or stop is determined, the AEB warning timing and/or braking control timing may be controlled to be earlier than the normal AEB control.

Referring to FIG. 3B, the target intention determination step S120B if the target is a front-side vehicle may include a step of determining whether the turn signal of the front-side vehicle is operating S121B. If the turn signal of the front-side vehicle is operating (‘Yes’ in S121B), it may be determined whether the direction of the turn signal corresponds to the direction of the driving lane of the ego vehicle (S122B). If the direction of the turn signal corresponds to the direction of the driving lane of the ego vehicle (‘Yes’ in S122B), of the target's intention to cut-in may be determined (S123B).

This is because if the driver of the front-side vehicle operates the turn signal towards the ego vehicle's driving lane, it may be estimated that the intention of the front-side vehicle's driver is to move into the ego vehicle's driving lane. Therefore, the intention of the target (front-side vehicle) to cut-in may be determined through whether the turn signal of the front-side vehicle is operating and the operating direction of the turn signal.

If it is determined that the front-side vehicle has an intention to cut-in, the control timing in the AEB control based on the front-side vehicle may be advanced. This is because if the front-side vehicle cuts into the driving lane of the ego vehicle, the collision risk with the front-side vehicle will increase. Therefore, if the intention of the front-side vehicle to cut-in is determined, the AEB warning timing and/or braking control timing may be controlled to be earlier than the normal AEB control.

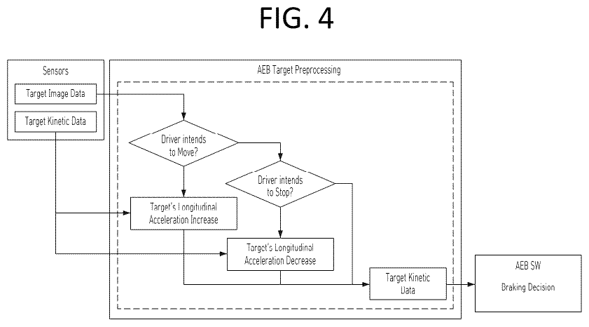

FIG. 4 is a diagram for explaining AEB target processing and a control method based on the determination of the target's intention to move or stop if the target is a front vehicle.

Referring to FIG. 4, image data and kinematic data of the target may be detected by sensor(s) equipped in the ego vehicle. Whether the driver intends to move or intends to stop may be determined from the target's image data (e.g., camera recognition data).

For example, if the brake light or turn signal of the front vehicle is not operating, it may be determined as intending to move forward. If the brake light of the front vehicle is operating, it may be determined as intending to stop.

Meanwhile, kinematic data of the target may be detected from at least one sensor(s) such as radar installed in the ego vehicle and/or body information sensors of the ego vehicle, allowing detection of distance to the target, relative speed with the target, etc. Further, based on the kinematic data, it may be determined whether the target's longitudinal acceleration is increasing or decreasing.

As such, during AEB control, by performing data processing considering both the image data (data related to target intention) and kinematic data (data related to target movement), the warning and/or braking timing in the AEB function may be optimized and controlled.

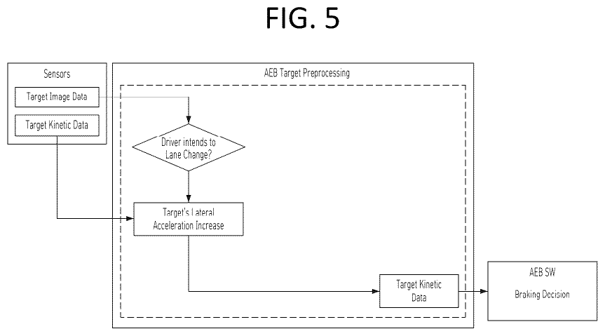

FIG. 5 is a diagram for explaining AEB target processing and a control method based on the determination of the target's cut-out/cut-in intention when the target is a front vehicle or front-side vehicle.

Referring to FIG. 5, image data and kinematic data of the target may be detected by at least one sensor(s) equipped in the ego vehicle. Whether the driver intends to change lanes may be determined from the target's image data (e.g., camera recognition data).

For example, if the turn signal of the front vehicle is operating, it may be determined as intending to cut-out. If the turn signal of the front-side vehicle is operating towards the driving lane of the ego vehicle, it may be determined as intending to cut-in.

Meanwhile, using the kinematic data detected from the target, it may be determined whether the target's lateral acceleration is increasing or decreasing.

As such, during AEB control, by performing data processing considering both the image data (related to target intention) and kinematic data (related to target movement), the warning and/or braking timing in the AEB function may be optimized and controlled.

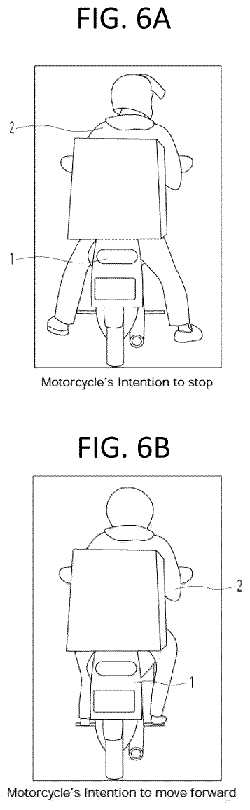

FIGS. 6A and 6B are diagrams for explaining the method of determining the target's intention if the target is a motorcycle in the method for controlling an AEB system according to the embodiment of the present disclosure.

Referring to FIGS. 6A and 6B, if the target is a motorcycle, intention of the target may be determined based on the posture of the motorcycle rider.

Specifically, if the rider 2 of the motorcycle 1 has a posture with their foot removed from the pedal (FIG. 6A), it may be determined that the motorcycle 1 has an intention to decelerate or stop. If the rider 2 of the motorcycle 1 has a posture with their foot placed on the pedal (FIG. 6B), it may be determined that the motorcycle 1 has an intention to move forward.

As described above, according to the embodiment, by determining the intention of the motorcycle to stop or move forward through the posture of the motorcycle rider, the change in the motion state of the target (motorcycle) can be predicted in advance. Accordingly, it is possible to optimize the AEB warning timing and/or the AEB braking control timing.

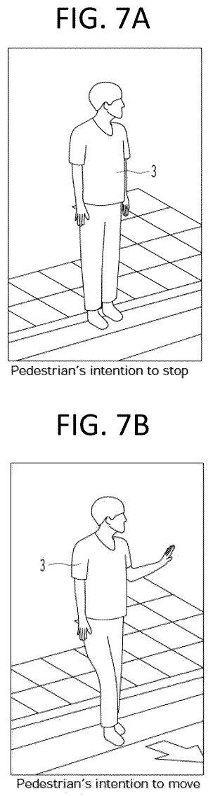

FIGS. 7A and 7B are diagrams for explaining the method of determining the target's intention if the target is a pedestrian in the method for controlling an AEB system according to the embodiment of the present disclosure.

Referring to FIGS. 7A and 7B, if the target is a pedestrian, intention of the target may be determined based on the posture of the pedestrian.

Specifically, if the pedestrian 3 is at the start portion of a crosswalk, and the posture of the pedestrian 3 is a standing posture (FIG. 7A), the intention of the target is determined as not entering the crosswalk. If the posture of the pedestrian 3 is a posture stepping forward (i.e., one foot of the pedestrian is extended forward) (FIG. 7B), the intention of the target is determined as entering the crosswalk.

Meanwhile, FIGS. 7A and 7B illustrates the case where the pedestrian is at the start portion of the crosswalk, but this is merely an example of determining intention based on the pedestrian's posture, and the AEB control may be performed based on determining the pedestrian's intention even if the pedestrian is at a different location. For example, if a pedestrian is located in the middle of a crosswalk in front of the ego vehicle, the intention to move of the pedestrian may be determined based on the pedestrian's posture, and the AEB control may be adjusted accordingly.

As described above, according to the embodiment, by determining the intention of the pedestrian to stop or move through the posture of the pedestrian, the change in the motion state of the target (pedestrian) can be predicted in advance. Accordingly, it is possible to optimize the AEB warning timing and/or the AEB braking control timing.

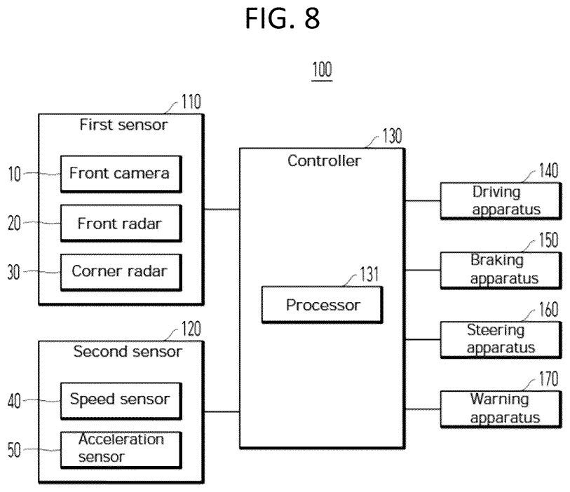

FIG. 8 is a control configuration diagram schematically showing the configuration of an apparatus for controlling an AEB system according to embodiments of the present disclosure.

Referring to FIG. 8, an apparatus for controlling an AEB system 100 according to the embodiments comprises: a first sensor 110 comprising a camera configured to recognize a target in surroundings of an ego vehicle; a second sensor 120 configured to detect body information of the ego vehicle; and a controller 130 comprising at least one processor 131 configured to control the AEB system by determining the intention of the target based on information collected from the first sensor 110 and the second sensor 120.

The controller 130 may determine the intention to decelerate or stop, intention to move forward, or intention to change direction of the target, and control at least one of the warning timing or braking timing of the AEB system according to the determined intention of the target.

The first sensor 110 may include a front camera 10 for collecting image data of the target. Further, the first sensor 110 may include at least one of a front radar 20 or a corner radar 30. However, the first sensor is not limited thereto, and may additionally include other types of sensors for detecting the surroundings of the vehicle, such as ultrasonic sensors, lidar sensors, etc.

The second sensor 120 may include at least one of a speed sensor 40 or an acceleration sensor 50. However, the second sensor 120 is not limited thereto, and may additionally include other types of sensors for detecting the body information of the ego vehicle, such as a steering angle sensor, a steering torque sensor, etc.

According to the embodiment, image data (camera recognition information) of the target may be collected by the first sensor 110, and kinematic data of the target may be collected by the first sensor 110 and/or the second sensor 120. Accordingly, by using both the image data and kinematic data of the target, it is possible to perform optimized AEB control according to the embodiments of the present disclosure.

Further, if the target is a front vehicle, the controller 130 may determine whether the turn signal is operating, and if turn signal is operating, the controller 130 may determine the intention of the target as intending to cut-out.

Further, the controller 130 may determine the intention of the target as intending to decelerate or stop if the brake light of the front vehicle is operating.

Further, if the target is a front-side vehicle, the controller 130 may determine whether the turn signal is operating, and if the turn signal is operating, the controller 130 may determine if the direction of the turn signal corresponds to the driving lane of the ego vehicle. If the direction of the turn signal corresponds to the driving lane, the controller 130 may determine the intention as intending to cut-in.

Further, if the target is a motorcycle, the controller 130 may determine the intention based on the rider's posture, and if the target is a pedestrian, the controller 130 may determine the intention based on the pedestrian's posture. For example, it may determine an intention to decelerate or stop if the motorcycle rider's foot is off the pedal, and an intention to move forward if the foot is on the pedal. For a pedestrian, if the pedestrian is at the start of a crosswalk, if the posture is a standing posture, the intention may be determined as not entering the crosswalk; and if the posture is a posture stepping forward, the intention may be determined as entering the crosswalk.

Further, the controller 130 may be connected to a braking apparatus 150 configured to perform braking control of the ego vehicle and a warning apparatus 170 configured to provide a warning to the driver of the ego vehicle. Accordingly, the controller 130 may controls at least one of the braking apparatus 150 or the warning apparatus 170 to perform the AEB control function according to the controlled warning timing and braking timing of the AEB system.

Here, the warning apparatus 170 may include at least one of a visual warning device, an audible warning device, or a haptic warning device. Accordingly, through visual, audible, and/or haptic warnings, the driver may be warned of the collision risk with the target according to the AEB function.

Further, the controller 130 according to the embodiment of the present disclosure may be connected to a driving apparatus 140 configured to control longitudinal driving of the ego vehicle and a steering apparatus 160 configured to control lateral driving of the ego vehicle. Accordingly, the controller 130 may control the driving of the ego vehicle by controlling at least one of the driving apparatus 140 or the steering apparatus 160 as needed.

Regarding the method for controlling the Autonomous Emergency Braking (AEB) system according to the embodiment of the present disclosure performed by the controller 130, since it has been described in detail previously, a detailed description thereof will be omitted here.

The disclosed embodiments may also be implemented as a computer-readable program on a computer-readable recording medium in order to be executed by a computer. A computer-readable recording medium may be a non-transitory computer-readable recording medium, such as a data storage device capable of storing data that may be read by a processor/microprocessor.

Examples of computer-readable recording media may include hard disk drives (HDD), solid-state drives (SSD), silicon disk drives (SDD), read-only memory (ROM), CD-ROM, magnetic tape, floppy disks, optical data storage devices, etc.

According to the embodiments of the present disclosure as described above, by utilizing kinematic information of the target as well as determining the intention of the target through image data for utilizing in AEB control, it is possible to provide a method and apparatus for controlling the AEB system that can rapidly cope with changes in the target's motion state, thereby preventing mis-control or non-control of the AEB system and improving the accuracy of AEB warning and braking determination.

Furthermore, according to the embodiments of the present disclosure, in cases where the target is a motorcycle or a pedestrian, by recognizing the posture of the rider or the pedestrian through camera information to predict changes in the target's motion state in advance and rapidly predict the target's path, it is possible to improve the performance of AEB warning and braking control.

The above description of the present disclosure is for illustrative purposes, and those skilled in the art may understand that it can be easily modified into other specific forms without changing the technical spirit or essential features of the present disclosure. Therefore, the embodiments described above should be understood as illustrative in all respects and not limiting. For example, each component described as a single type may be implemented in a distributed manner, and similarly, components described as distributed may be implemented in a combined form.

The scope of the present disclosure is indicated by the following claims rather than the above detailed description, and all changes or modifications derived from the meaning and scope of the claims and equivalent concepts should be interpreted to be included in the scope of the present disclosure.

### EXPLANATION OF REFERENCE

1: Motorcycle
2: Rider of motorcycle
3: Pedestrian
10: Front camera
20: Front radar
30: Corner radar
40: Speed sensor
50: Acceleration sensor
100: Apparatus for controlling AEB system
110: First sensor
120: Second sensor
130: Controller
131: Processor
140: Driving apparatus
150: Braking apparatus
160: Steering apparatus
170: Warning apparatus

What is claimed is:

1. A method for controlling an Autonomous Emergency Braking (AEB) system, comprising:
recognizing a target in surroundings of an ego vehicle using a camera installed at the ego vehicle;
determining an intention of the target using recognition information of the camera, the intention comprising at least one of an intention to decelerate or stop, an intention to move forward, or an intention to change direction; and
controlling at least one of a warning timing or a braking timing of the AEB system of the ego vehicle, based on the determined intention of the target.

2. The method of claim 1, wherein the target is one of a front vehicle, a front-side vehicle, a motorcycle, or a pedestrian.

3. The method of claim 2, wherein the determining of the intention of the target comprises:
if the target is the front vehicle, determining whether a turn signal of the front vehicle is operating; and
if the turn signal is operating, determining the intention of the target as an intention to cut-out.

4. The method of claim 3, wherein the determining of the intention of the target further comprises:
if the turn signal of the front vehicle is not operating, determining whether a brake light of the front vehicle is operating; and
if the brake light is operating, determining the intention of the target as an intention to decelerate or stop.

5. The method of claim 2, wherein the determining of the intention of the target comprises:
if the target is the front-side vehicle, determining whether a turn signal of the front-side vehicle is operating;
if the turn signal of the front-side vehicle is operating, determining whether a direction of the turn signal corresponds to a direction towards a driving lane of the ego vehicle; and
if the direction of the turn signal corresponds to the direction towards the driving lane, determining the intention of the target as an intention to cut-in.

6. The method of claim 2, wherein the determining of the intention of the target comprises:
if the target is the motorcycle, determining the intention of the target based on a posture of a rider of the motorcycle.

7. The method of claim 6, wherein the determining of the intention of the target comprises:
determining the intention as an intention to decelerate or stop if the posture is a posture that the rider has removed a foot from a pedal; and
determining the intention as an intention to move forward if the posture is a posture that the rider has placed a foot on the pedal.

8. The method of claim 2, wherein the determining of the intention of the target comprises:
if the target is the pedestrian, determining the intention of the target based on a posture of the pedestrian.

9. The method of claim 8, wherein if the pedestrian is at a start portion of a crosswalk, the intention of the target is determined as an intention not to enter the crosswalk if the posture of the pedestrian is a standing posture, and the intention of the target is determined as an intention to enter the crosswalk if the posture of the pedestrian is a posture stepping forward.

10. An apparatus for controlling an Autonomous Emergency Braking (AEB) system, comprising:
a first sensor comprising a camera configured to recognize a target in surroundings of an ego vehicle;
a second sensor configured to detect body information of the ego vehicle; and
a controller comprising at least one processor configured to control the AEB system of the ego vehicle by determining an intention of the target based on information collected from the first sensor and the second sensor,
wherein the controller is configured to:
determine the intention of the target, the intention comprising at least one of an intention to decelerate or stop, an intention to move forward, or an intention to change direction; and
control at least one of a warning timing or a braking timing of the AEB system based on the determined intention of the target.

11. The apparatus of claim 10, wherein the target is one of a front vehicle, a front-side vehicle, a motorcycle, or a pedestrian.

12. The apparatus of claim 11, wherein if the target is the front vehicle, the controller is configured to: determine whether a turn signal of the front vehicle is operating; and if the turn signal is operating, determine the intention of the target as an intention to cut-out.

13. The apparatus of claim 12, wherein the controller is configured to: if the turn signal of the front vehicle is not operating, determine whether a brake light of the front vehicle is operating; and if the brake light is operating, determine the intention of the target as an intention to decelerate or stop.

14. The apparatus of claim 11, wherein if the target is the front-side vehicle, the controller is configured to: determine whether a turn signal of the front-side vehicle is operating; determine whether a direction of the turn signal corresponds to a direction towards a driving lane of the ego vehicle; and if the direction of the turn signal corresponds to the direction towards the driving lane, determine the intention of the target as an intention to cut-in.

15. The apparatus of claim 11, wherein if the target is the motorcycle, the controller is configured to determine the intention of the target based on a posture of a rider of the motorcycle.

16. The apparatus of claim 15, wherein the controller is configured to: determine the intention as an intention to decelerate or stop if the posture is a posture that the rider has removed a foot from a pedal;
and determine the intention as an intention to move forward if the posture is a posture that the rider has placed a foot on the pedal.

17. The apparatus of claim 11, wherein if the target is the pedestrian, the controller is configured to determine the intention of the target based on a posture of the pedestrian.

18. The apparatus of claim 17, wherein the controller is configured to: if the pedestrian is at a start portion of a crosswalk, determine the intention of the target as an intention not to enter the crosswalk if the posture of the pedestrian is a standing posture; and
determine the intention of the target as an intention to enter the crosswalk if the posture of the pedestrian is a posture stepping forward.

19. The apparatus of claim 10, wherein the controller is connected to: a braking apparatus configured to perform braking control of the ego vehicle; and a warning apparatus configured to provide a warning to a driver of the ego vehicle, and
wherein the controller is configured to control at least one of the braking apparatus or the warning apparatus according to the controlled warning timing or braking timing of the AEB system to perform an AEB function.

20. A non-transitory computer-readable recording medium that records a program for executing a method for controlling an Autonomous Emergency Braking (AEB) system on a computer, the method comprising:
recognizing a target in surroundings of an ego vehicle using a camera installed at the ego vehicle;
determining an intention of the target using recognition information of the camera, the intention comprising at least one of an intention to decelerate or stop, an intention to move forward, or an intention to change direction; and
controlling at least one of a warning timing or a braking timing of the AEB system of the ego vehicle, based on the determined intention of the target.
